(19) United States
(12) Patent Application Publication
(10) Pub. No.: US 2022/0171338 A1
(43) Pub. Date: Jun. 2, 2022

(54) BALANCE CLEARANCE ADJUSTMENT FIXING DEVICE

(71) Applicant: ETA SA Manufacture Horlogère Suisse, Grenchen (CH)

(72) Inventors: Julien SAGLINI, Bienne (CH); Raphaël COURVOISIER, Corcelles (CH)

(73) Assignee: ETA SA Manufacture Horlogère Suisse, Grenchen (CH)

(21) Appl. No.: 17/476,994

(22) Filed: Sep. 16, 2021

(30) Foreign Application Priority Data
Nov. 27, 2020 (EP) 20210242.2

(51) Int. Cl. G04B 18/06; G04B 18/02

(52) U.S. Cl. CPC G04B 18/06; G04B 18/026

(57) ABSTRACT

A fixing device for adjusting the clearance of a balance. At least one fixing device including at least one stud holder, at least one bearing body, at least one support member and at least one holding member. At least one bearing body is configured to move relative to at least one stud holder so as to fix the adjustment of the clearance of the balance and at least one support member is configured to press at least one bearing body against at least one stud holder before being held by at least one holding member.

### TECHNICAL FIELD OF THE INVENTION

The present invention relates to the field of watchmaking. It relates more particularly to fixing devices for adjusting the balance clearance.

### TECHNOLOGICAL BACKGROUND

The adjustment of the balance clearance is essential for the proper operation of a mechanical movement. Equally important is the positioning and locking of the stud holder and the balance shock-absorber. In most mechanical movements, the shock-absorber is driven into the balance bridge, itself locking the stud holder.

To adjust these two elements, it is necessary to exert a significant force on these elements which is tedious and can cause degradation of said elements and their environment.

### SUMMARY OF THE INVENTION

The present invention relates to a fixing device for adjusting the clearance of a balance, preferably for adjusting the clearance of said balance; said at least one fixing device comprising at least one stud holder, at least one:
bearing body; said at least one bearing body being configured to move relative to said at least one stud holder;
support member; said at least one support member being configured to press said at least one bearing body against said at least one stud holder; and,
holding member; said at least one holding member being configured to hold said at least one support member pressed against said at least one bearing body so as to fix the adjustment of said clearance of said balance.

Thanks to this arrangement, said fixing device allows to adjust said at least one stud holder and the positioning of said at least one bearing body without having to exert significant forces, and allows to guarantee the functionality of the movement and a good resistance during shocks.

According to one embodiment, said fixing device comprises at least one balance bridge configured to cooperate with said at least one holding member.

Thanks to this arrangement, said at least one holding member can cooperate with said at least one balance bridge.

According to one embodiment, said at least one bearing body is configured to be comprised between said at least one stud holder and said at least one support member.

Thanks to this arrangement, the adjustment of said at least one bearing body is maintained thanks to said at least one stud holder and said at least one support member.

According to one embodiment, said at least one support member comprises a first support surface configured to press said at least one bearing body against said at least one stud holder and at least one second support surface configured to be in contact with said at least one holding member.

Thanks to this arrangement, said at least one support member transmits the force of said at least one holding member to said at least one bearing body.

According to one embodiment, said at least one bearing body comprises a tapping or a thread disposed on the outer periphery of said at least one bearing body and said at least one stud holder comprises a thread or a tapping disposed on the inner periphery of said at least one stud holder.

Thanks to this arrangement, said at least one bearing body can be screwed to said at least one stud holder.

### BRIEF DESCRIPTION OF THE FIGURES

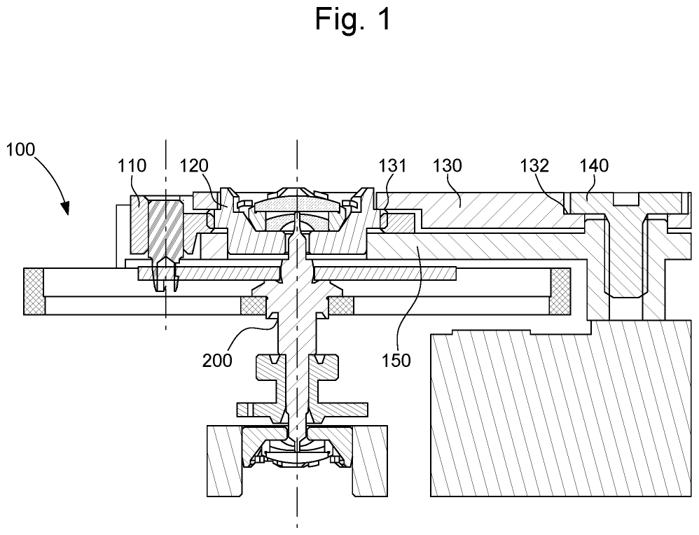

The invention will be described in more detail below using the appended drawing, given by way of non-limiting example, wherein FIG. 1 represents a balance clearance adjustment fixing device.

### DETAILED DESCRIPTION OF THE INVENTION

The adjustment of the balance clearance is essential for the proper operation of a mechanical movement. To this end, the applicant proposes a fixing device 100 for adjusting the clearance of a balance 200. Said at least one fixing device 100 comprising at least one stud holder 110, at least one bearing body 120, at least one support member 130 and at least one holding member 140.

As shown in FIG. 1, said at least one bearing body 120 is configured to move relative to said at least one stud holder 110 through a thread-tapping.

Indeed, according to the embodiments, said at least one bearing body 120 may comprise a tapping or a thread disposed on the outer periphery of said at least one bearing body 120. Said at least one stud holder 110, in turn, may comprise a thread or a tapping disposed on the inner periphery of said at least one stud holder 110 so that said at least one bearing body 120 can be screwed to said at least one stud holder 110 and thus adjust the clearance of said balance 200.

Said at least one support member 130 is configured to press said at least one bearing body 120 against said at least one stud holder 110 and said at least one holding member 140 allows to hold said at least one support member 130 pressed against said at least one bearing body 120 so as to fix the adjustment of said clearance of said balance 200 and therefore the positioning of said at least one bearing body 120 without having to exert significant forces while ensuring the functionality of the movement and good resistance during shocks. In other words, said at least one bearing body 120 may be comprised between said at least one stud holder 110 and said at least one support member 130 so as to be held by means of said at least one stud holder 110 and said at least one support member 130.

This hold can be improved by means of support surfaces present on said at least one support member 130. Indeed, said at least one support member 130 comprises a first support surface 131 allowing to press said at least one bearing body 120 against said at least one stud holder 110 and at least one second support surface transmitting the holding force exerted by said at least one holding member 140 to said at least one bearing body 120.

The whole, that is to say said at least one stud holder 110, said at least one bearing body 120, said at least one support member 130 and said at least one holding member 140, rests on at least one balance bridge 150 configured to cooperate with said at least one holding member 140.

1. A fixing device for adjusting a clearance of a balance, said at least one fixing device comprising at least one stud holder, at least one:
bearing body; said at least one bearing body being configured to move relative to said at least one stud holder;
support member; said at least one support member being configured to press said at least one bearing body against said at least one stud holder; and,
holding member; said at least one holding member being configured to hold said at least one support member pressed against said at least one bearing body so as to fix the adjustment of said clearance of said balance.

2. The fixing device according to claim 1, which comprises at least one balance bridge configured to cooperate with said at least one holding member.

3. The fixing device according to claim 1, wherein said at least one bearing body is configured to be comprised between said at least one stud holder and said at least one support member.

4. The fixing device according to claim 1, wherein said at least one support member comprises a first support surface configured to press said at least one bearing body against said at least one stud holder and at least one second support surface configured to be in contact with said at least one holding member.

5. The fixing device according to claim 1, wherein said at least one bearing body comprises a tapping or a thread disposed on the outer periphery of said at least one bearing body and said at least one stud holder comprises a thread or a tapping disposed on the inner periphery of said at least one stud holder.
